(19) United States
(12) Patent Application Publication
(10) Pub. No.: US 2024/0381131 A1
(43) Pub. Date: Nov. 14, 2024

(54) SELF-HEALING METHOD FOR FRONTHAUL COMMUNICATION FAILURES IN CASCADED CELL-FREE NETWORKS

(71) Applicant: Telefonaktiebolaget LM Ericsson (publ), Stockholm (SE)

(72) Inventors: André Lucas PINHO FERNANDES, Belém Pará (BR); Lucas SANTIAGO FURTADO, Belém Pará (BR); Roberto MENEZES RODRIGUES, Belém Pará (BR); João C. WEYL ALBUQERQUE COSTA, Belém Pará (BR); Gilvan SOARES BORGES, Belém Pará (BR); Andre MENDES CAVALCANTE, Indaiatuba SP (BR); Maria VALÉRIA MARQUEZINI, Indaiatuba (BR); Igor ALMEIDA, Indaiatuba SP (BR)

(21) Appl. No.: 18/696,447

(22) PCT Filed: Sep. 30, 2021
(86) PCT No.: PCT/IB2021/059016

§ 371 Date: Mar. 28, 2024

(51) Int. Cl. H04W 24/04; H04B 7/024; H04W 72/21; H04W 72/23

(52) U.S. Cl. CPC H04W 24/04; H04W 72/21; H04W 72/23; H04B 7/024

(57) ABSTRACT

A method performed by a CPU of a cascade cell-free massive MIMO network where APs are connected in a cascaded fronthaul chain to the CPU using a shared fronthaul bus. An AP at the end of the cascaded fronthaul chain is assigned as a last AP. Responsive to determining that fronthaul UL data is received by the CPU from the last AP, it is determined that the last AP is healthy. Responsive to fronthaul UL data not being received for a period of time, data addressed to the last AP is transmitted through DL broadcast structure of the shared fronthaul bus; Responsive to the ACK signal being received, it is determined that the last AP is healthy and responsive to the ACK signal not being received, it is determined that a fronthaul segment until the last AP is not healthy.

### TECHNICAL FIELD

The present disclosure relates generally to communications, and more particularly to communication methods and related devices and nodes supporting wireless communications.

### BACKGROUND

The ever-increasing demand for data and quality of service (QOS) has been pushing the evolution of mobile communications. Regarding the mobile systems of fifth-generation (5G) and beyond, cell-free massive MIMO (Multiple-Input and Multiple-Output) networks are one of the main candidates to meet the future demands. Composed of a large set of distributed access points (APs), that kind of network co-processes and transmits the user signal using multiple APs. That approach provides macro-diversity gain and results in a more uniform spectral efficiency (SE) over the coverage area when compared to centralized massive MIMO.

Despite that, the traditional design of Cell-free (CF) massive MIMO networks employs a star topology, with a separate link between each AP and a central processing unit (CPU), which may be complex and cost-prohibitive for wide-area networks. A more scalable approach is a compute-and-forward architecture, where cascaded fronthaul links interconnect a CPU with multiple APs. An example of this is a system where circuit-mounted chips acting as access points units (APUs) are serially connected inside a cable or stripe using a shared bus, providing power, synchronization, and fronthaul communication, which in the downlink (DL) has a broadcast structure while in the uplink (UL) has a pipe-line structure. Such a system, referred to as a radio stripe system, allows cheap distributed massive MIMO deployment as each stripe or cable needs only one (plug and play) connection to the CPUs, which makes installation a network roll-out in the true sense, without need for any highly qualified personnel. The cables or stripes can be placed anywhere, at any ordinary length to meet needs of specific scenarios, providing a truly ubiquitous and flexible deployment. Finally, an extra advantage of that system over cellular APs is the low heat-dissipation, which makes cooling systems simpler and cheaper.

Nevertheless, the availability/reliability of the fronthaul connection chain for cascaded CF massive MIMO networks is an important issue to be considered. A communication failure and consequently inoperability of a fronthaul segment will cause an outage in all the following fronthaul segments (including APs on the chain of connections) as well, reducing macro-diversity and consequently the spectral efficiency (SE).

There currently exist certain challenge(s). Solutions for cascaded cell-free massive MIMO networks that have been proposed do not present a proper way to compensate for the communication availability/reliability problems of using cascaded connections. Consequently, failures on the fronthaul segments can cause potentially high coverage quality degradation, due to a reduction in macro-diversity. This is especially true when a failure happens closer to the CPU because this will cause an outage to a bigger number of APs. Therefore, fronthaul segment communication failure identification and compensation are needed.

### SUMMARY

Certain aspects of the disclosure and their embodiments may provide solutions to these or other challenges. According to some embodiments, a self-healing method for fronthaul communication failures in cascaded cell-free massive MIMO networks based on a radio stripe system (RSS) is provided. Various embodiments identify fronthaul communication failures (on APs or on the fronthaul bus) and adequately compensates them. Some of these embodiments basically divide the self-healing method into two procedures: (1) a failure detection procedure and (2) a compensation procedure. In the failure detection procedure, the communication failure and its cause are determined through detecting fronthaul downlink signals by a predefined AP belonging to the fronthaul link under checking. In the compensation procedure, the APs and components belonging to the compromised fronthaul segment start a distributed interconnection mechanism with external active fronthaul links (belonging to the same CPU or not). The CPUs of the fronthaul links involved in the interconnection procedure, negotiate to schedule and establish final interconnections according to their demands, capacities, and type of failure. The self-healing methodology creates alternative fronthaul routes for compensating the identified fronthaul communication failure, reducing the degradation of the system spectral efficiency

According to some embodiments, a method performed by a central processing unit, CPU, of a cascade cell-free massive multiple-input and multiple-output, MIMO, network where access points, APs, are connected in a cascaded fronthaul chain to the CPU using a shared fronthaul bus, the method for each shared fronthaul bus of the CPU that is active includes assigning an AP at the end of the cascaded fronthaul chain as a last AP. The method further includes responsive to determining that fronthaul uplink, UL, data is received by the CPU from the last AP, determining that the last AP is healthy. The method further includes responsive to fronthaul UL data not being received for a period of time: transmitting data addressed to the last AP through downlink, DL, broadcast structure of the shared fronthaul bus; determining if an acknowledgement, ACK, signal of the data is received by the CPU in a UL pipeline communication structure; responsive to the ACK signal being received, determining that the last AP is healthy; and responsive to the ACK signal not being received, determining that a fronthaul segment until the last AP is not healthy.

Analogous CPUs are also provided.

Certain embodiments may provide one or more of the following technical advantage(s). Higher fronthaul availability & reliability, and CF massive MIMO network feasibility can be achieved: Some of the various embodiments can effectively improve the fronthaul availability and reliability for all APs in the network, increasing the feasibility and service life of unsupervised cascaded cell-free massive MIMO networks.

Various embodiments provide failure identification and compensation in a distributed fashion: The failure detection and compensation procedure are initiated on the APs in a distributed fashion, without the dependency on the CPU. Failures can happen anywhere, thus the use of APs for distributed identification and compensation is more adequate than a centralized system on CPUs, especially since failures can result in loss of connection between APs and CPUs, which the latter having no options to contact APs in an outage of service.

Low impacts in AP hardware complexity can be achieved: The failure detection and

compensation algorithms are very simple, implying very little hardware demand in APs. Besides that, they only use typical fronthaul DL data/control signals that may be already employed for other functions on APs.

Low-Cost fronthaul redundancy may be achieved: The various embodiments use dynamically created interconnections to provide an alternative fronthaul route to APs in a service outage. These can be cheap, for example, a new fronthaul connection can be realized through unused or low-loaded APs, implying no additional equipment. Besides that, even if a less-cheaper wired interconnection is used, the method will work with a reduced number of them, minimizing costs.

According to other embodiments, a method performed by a last access point, AP, of a cascaded cell-free massive multiple-input and multiple-output, MIMO, network where access points, APs, are connected in a cascaded chain to a central processing unit, CPU, using a shared fronthaul bus includes responsive to receiving any signal from a downlink, DL, fronthaul data, determining that the shared fronthaul bus is healthy. The method further includes verifying whether acknowledgement signals are received on DL fronthaul data received for transmitted uplink, UL, fronthaul data. The method further includes responsive to acknowledgement signals being received, determining) that an AP cascaded chain is healthy. The method further includes responsive to acknowledgement signals not being received after a period of time, determining that a failure has occurred in the AP cascaded chain.

Analogous last APs are also provided.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of a single cascaded cell-free massive MIMO network;

FIGS. 2A-2C are illustrations of a self-healing method for fronthaul communication failures according to some embodiments of inventive concepts;

FIG. 3 is a flowchart illustrating a fronthaul identification and compensation method according to some embodiments of inventive concepts;

FIG. 4 is a simplified overview of two fronthaul interconnection technologies compatible with the various embodiments of inventive concepts;

FIG. 5 is an illustration of a simulation scenario according to some embodiments of inventive concepts;

FIG. 6 is an illustration of a cumulative distribution function versus spectral efficiency according to some embodiments of inventive concepts;

FIG. 7 is a block diagram illustrating an access point according to some embodiments of inventive concepts;

FIGS. 8-12 are flow charts illustrating operations of a CPU of a radio strip system according to some embodiments of inventive concepts; and

FIGS. 13-14 are flow charts illustrating operations of a last AP according to some embodiments of inventive concepts.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, solutions for cascaded cell-free massive MIMO networks do not present a proper way to compensate for the communication availability/reliability problems of using serial connections. Consequently, failures on the fronthaul segments can cause potentially high coverage quality degradation, due to a reduction in macro-diversity. This is especially true when a failure happens closer to the CPU because this will cause an outage to a bigger number of APs.

For cascaded cell-free massive MIMO networks that convey fronthaul data through a broadcast communication structure for downlink and pipe-line for uplink, an AP failure adds an additional challenge for the fronthaul segment failure compensation, since in this case, only the fronthaul uplink data will be affected. Then, solutions for fronthaul segment failure compensation should consider adequately the fronthaul communication structure to compensate both bus and AP failures.

In wired access, increasing availability requirements lead to the development of protection schemes that guarantee fallback. In general, most of these protection schemes fall into four categories: total duplication, selective duplication, overload with cross-connection, and parallel system. The first category uses two identical network meshes. If a failure occurs on the primary mesh, the spare mesh is activated. The second category duplicates only some of the components of the primary network mesh, generally the ones more impactful to network availability. The third, cross-connect some elements of the network mesh, providing alternative paths that can be used in failures. In such a way that part of the network mesh will probably be overloaded. The last category is similar to the first because two or more network meshes support each user. However, none of the meshes have just a backup function. They are primary meshes for different communication systems

In wireless access, e.g., Wi-Fi or 3G/4G/5G networks, base stations (BSs) or access points (APs) may become incapable of providing a useful signal to any mobile users. This fact can happen due to BS/AP failure or backhaul connection outage. The traditional technique to guarantee service continuity to users initially connected to BSs under failure/outage is changing antenna tilt and increase transmission power in neighboring BSs/APs. Despite that, there may be a reduction in performance metrics for the users initially connected to the BS under failure/outage. Besides, the network may even drop some users when neighboring BSs/APs are already operating closer to their maximum number of users. A proposed way to avoid these problems is to utilize mobile base stations transported by unmanned aerial vehicles (UAVs), which serves users that would be dropped or suffer intense performance degradation on the traditional healing approach. In such a way that each aerial mobile base station does the backhauling its traffic through Line-of-Sight (LOS) connections to ground fixed base stations. A backhaul topology based on wired access selective duplication can minimize

backhaul outage impacts. Despite this, it may be possible to entirely avoid backhaul outage by utilizing AP with redundant backhaul connection ports (for the same or different access means) or adding a self-healing radio (SHR) to BSs/APs. The first case is equivalent to wired access total duplication or parallel system protection schemes. The second case considers that additional hardware (the SHR) is installed on each BS/AP. These SHRs can cross-connect to each other, redirecting the backhauling of a BS/AP under outage wirelessly to a BS/AP with functional backhaul. In the end, this procedure is equivalent to an overload with a cross-connection protection scheme of wired access networks. SHR has been investigated, but only for traditional cellular heterogeneous perspective without considering distributed MIMO systems.

Various embodiments of inventive concepts provide a self-healing approach capable of minimizing the effects of AP/fronthaul link failure providing fallbacks in cascaded cell-free massive MIMO networks, which are essentially distributed massive MIMO systems. The method is not dependent on network mesh duplication or redundant fronthaul ports on AP, although it can utilize these. Besides that, different from SHR, in the wireless interconnection between APs, no additional hardware is needed on any AP in the distributed MIMO systems.

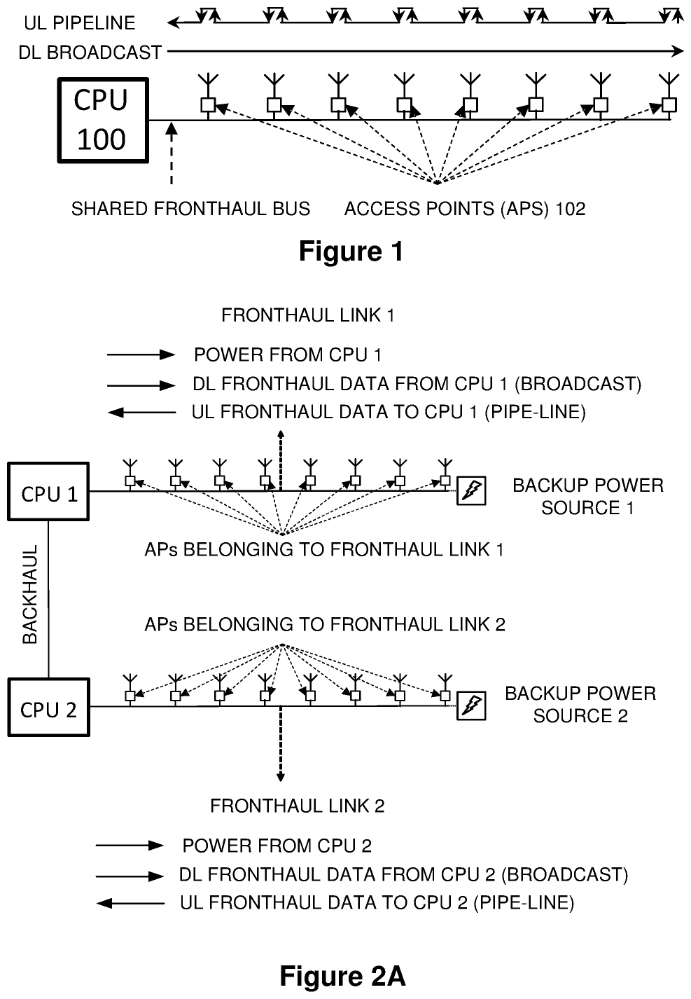

The various embodiments refer to a cascaded cell-free massive MIMO network based on a radio stripe system, such as the Ericsson Radio Strip System, where access points (APs) are serially connected to a Central Processing Unit (CPU) using a shared fronthaul bus, that provides power, synchronization, and fronthaul communication (broadcast structure for DL and compute-and-forward for UL). A single cascaded cell-free network is illustrated in FIG. 1

The various embodiments of inventive concepts assume the following:
the CPU and APs (n) know the order of the N serially connected APs in the fronthaul bus under checking. The AP with less fronthaul length is assigned as the first and the AP with more fronthaul length as the last (L);
APs are connected over fronthaul links of unlimited capacity. Also, the remaining network infrastructure (CPUs, backhaul and core network) have no power or capacity restrictions;
An interconnection technology (wired or wireless) between different fronthaul links is available without CPU connection;
A backup power source on the opposite extremity of a fronthaul link in relation to CPU is required for fronthaul bus failure compensation;
Signaling through acknowledgment signals (ACKs) is necessary. Nevertheless, signaling already employed for other functions on APs or utilized for other solutions in cell-free networks can be re-utilized.

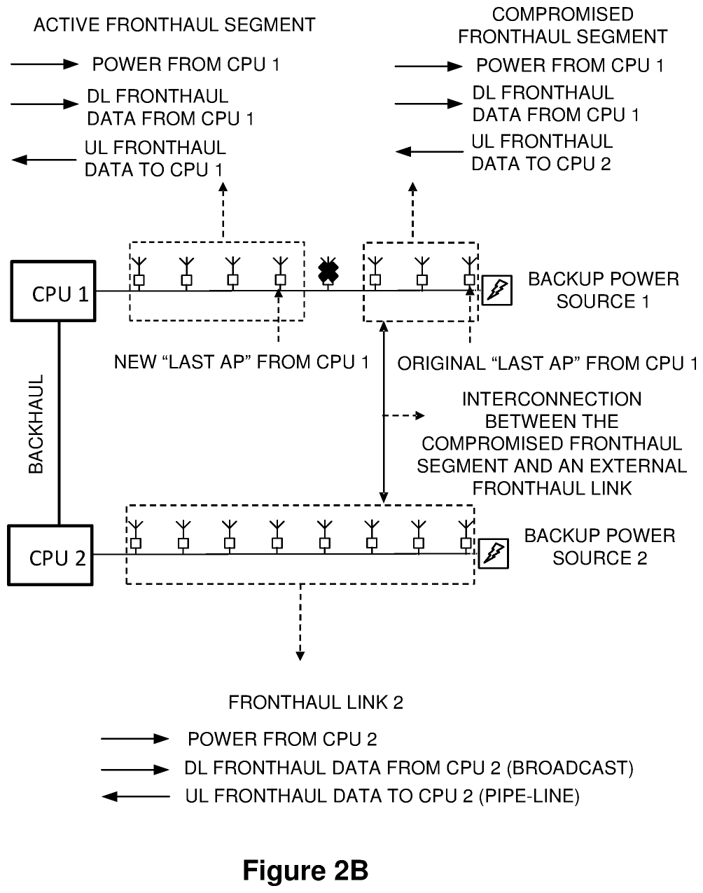

Various embodiments of a self-healing method for fronthaul communication failures firstly identifies the failure and determines its cause, which can be on some AP on the serial chain or on some section of the shared fronthaul bus carrying data, synchronization, and power. This failure detection procedure is performed by a pre-defined AP, called as “last AP” (or “failure detection AP”) and belongs to the fronthaul link under checking, through detecting fronthaul downlink (DL) signals. After a fronthaul communication failure and its cause are determined, the “last AP” notifies the failure type to the other APs of the compromised fronthaul segment using the fronthaul uplink (UL) pipeline communication structure (i.e., compute-and-forward). After that, all these APs (i.e., in compromised fronthaul segment) initiate a distributed interconnection request procedure with external active fronthaul links (belonging to the same CPU or not). The fronthaul interconnection establishment (i.e., the compensation procedure) and its communication structure depend on the type of failure. In case of AP failure occurs, the interconnection between the fronthaul links (external and compromised segment) will carry just UL fronthaul data from the compromised segment. In this case, a backup power source is not needed since this type of failure only affects the UL fronthaul pipeline structure and the DL fronthaul communication and power delivery are still working. In case of a fronthaul bus failure, a backup power source is required to deliver power to the compromised (disconnected) fronthaul segment and the interconnection between the fronthaul links (external and compromised) will carry both UL and DL fronthaul data. The compensation procedure is finalized when the CPU of the fronthaul links involved in the interconnection procedure, negotiate to schedule and establish final interconnections according to their demands, capacities, and type of failure. Whereupon the fronthaul segment communication failure is compensated, and degradation of the system spectral efficiency is reduced. For clarification, FIGS. 2A-2C present illustrative examples of the self-healing method for fronthaul communication failures in a cascaded cell-free network composed by two fronthaul links of different CPUs.

FIG. 2A illustrates two active fronthaul links in a cell-free network where both fronthaul links are operating normally. Fronthaul link 1 receives power from CPU 1. Downlink (DL) fronthaul data is broadcast from CPU 1. Uplink (UL) fronthaul data is sent to CPU 1. Similarly, fronthaul link 2 receives power from CPU 2. Downlink (DL) fronthaul data is broadcast from CPU 2. Uplink (UL) fronthaul data is sent to CPU 2.

FIG. 2B illustrates the two active fronthaul links of FIG. 2A but with a failure in the serial chain of Access Points (APs). Fronthaul 2 operates normally like in FIG. 2A. In Fronthaul 1, a new “last AP” from CPU 1 is the last AP before the failed AP whereas the original “last AP” was the last AP in the serial chain. The active fronthaul segment receives power from CPU 1; DL fronthaul data is from CPU 1, and UL fronthaul data is to CPU 1. An interconnection is negotiated and established between the compromised fronthaul segment and an external fronthaul link. The compromised fronthaul segment receives power from CPU 1, DL fronthaul data is from CPU 1, and UL fronthaul data is sent to the external fronthaul link, which in FIG. 2B is CPU 2.

FIG. 2C illustrates the two active fronthaul links of FIG. 2A but with a fronthaul bus failure. Fronthaul 2 operates normally like in FIG. 2A. In Fronthaul 1, a new “last AP” from CPU 1 is the last AP before fronthaul bus failure whereas the original “last AP” was the last AP in the serial chain. The active fronthaul segment receives power from CPU 1; DL fronthaul data is from CPU 1, and UL fronthaul data is to CPU 1. An interconnection is negotiated and established between the compromised fronthaul segment and an external fronthaul link. The compromised fronthaul segment receives power from backup power 1, DL fronthaul data is from the external fronthaul link (CPU 2), and UL fronthaul data is sent to the external fronthaul link (CPU 2).

It is important to mention that the fronthaul interconnection can be established using different technologies (wired or wireless) and some of them require little or no additional equipment to protect the fronthaul, as for example, wireless interconnection using unused or low-loaded APs. In this way, better fronthaul availability and reliability can be achieved at an affordable cost. The details on some fronthaul interconnection approaches are described later.

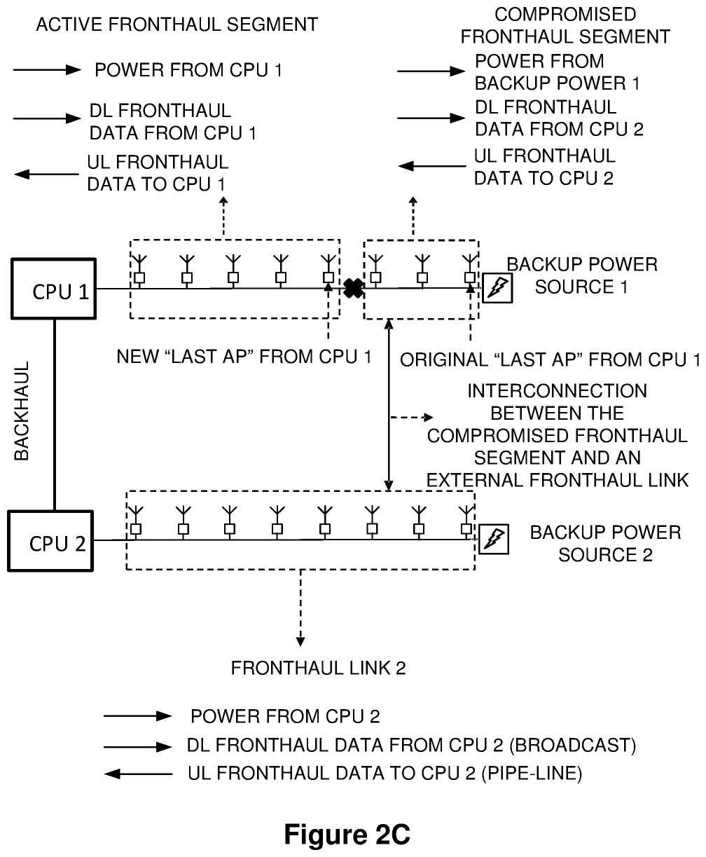

Turning to FIG. 3, operations that the APs and CPUs of the fronthaul link shall now be described. Note that certain sets of blocks in the chart are performed by different respective devices and these blocks can stand alone as separate methods. For example, blocks 301-307 and 323-333 are performed by CPUs and these blocks can stand alone as a separate method. Similarly, blocks 309-321 are performed by the last APs and these blocks can stand alone as a separate method.

Blocks 301-307 of FIG. 3A are part of a procedure for last AP health check and assignment. In block 301, the CPU periodically performs a health check of the “last AP L” for each of the CPU's active fronthaul links. The “last AP” is responsible for failure detection in the procedure for failure detection (with failure type identification) as described below.

For each fronthaul link from CPU, the procedure to check the health of the “last AP L” and possible “last AP” reassignment is performed as follows: The CPU initially assigns the “last AP” as the actual last AP in the chain (e.g., L=N).

If fronthaul UL data from the “last AP” (e.g., AP L) is being received by the CPU in block 301, then the assigned “last AP” is healthy as determined in block 303 and no further health check actions are performed until the next health check.

However, if fronthaul UL data from the last AP (initially AP L) is not being received by the CPU for some time, the CPU sends data addressed to the last AP (initially AP L) through the DL broadcast communication structure. If an acknowledgment signal (ACK) of the data sent is received by CPU in the UL pipeline communication structure, then the assigned “last AP” is healthy, and no further actions are necessary. If no acknowledgment signal (ACK) of the data sent is received by the CPU in the UL pipeline communication structure, then the CPU concludes that the fronthaul segment until the AP L is unhealthy. In this case, the CPU will reassign the “last AP” as (L=L−1) in block 305 and the procedure of blocks 301-305 is repeated. In some embodiments, the procedure of block 301-305 is repeated until an AP is determined to be healthy and that AP is assigned to be the “last AP” in block 307.

Block 309 to 317 of FIG. 3A are part of a failure detection procedure. In this procedure, for a fronthaul link under checking, the assigned last AP verifies the detection of signals.

If any signal is received by the last AP, then the fronthaul bus is healthy as determined in block 309. In block 311, the last AP verifies the receiving of acknowledgment signals (ACKs) on the received DL fronthaul data for its transmitted UL fronthaul data, to verify the AP serial chain health. If there are ACKs received, then the AP serial chain is healthy and the fronthaul link is operating in normal operation as illustrated by block 313. If there is no ACK received after some time (e.g., after a designated time period) by the last AP, the last AP determines that AP serial chain failure has occurred in block 315.

In no signal is received by the last AP after some time (after a designated time period, which may be the same as or different from the designate period for determining AP serial chain failure, then the last AP determines in block 317 that fronthaul bus failure has occurred.

A failure compensation procedure is illustrated in blocks 317-333 of FIG. 3B after the failure detection in a fronthaul link has been detected. The last AP informs the occurrence and type of failure via UL fronthaul pipe-line communication structure to the APs n<“last AP” and other components on the compromised fronthaul segment (failed part) in block 319.

In block 321, each one of the APs (i.e., APs n<“last AP”) and the last AP initiates a fronthaul interconnection request procedure with external active fronthaul links (belonging to the same CPU or not). This request procedure can be implementation-defined, but it can be performed by mimicking the initial access procedure performed by a User Equipment (UE) with some special indication for fronthaul interconnection.

In block 323, the CPUs of the external fronthaul links that received fronthaul interconnection requests will inform the failure to the CPU with the compromised fronthaul communication via backhaul connection. If the interconnected and compromised fronthaul links are on the same CPU, the backhaul connection is not needed to inform the failure.

In block 325, the CPU with the compromised fronthaul link assigns a new last AP to this fronthaul link as being the last AP in the non-compromised fronthaul segment. This CPU performs blocks 301-307 in some embodiments to assign the new last AP. Note that if the CPU with compromised fronthaul link does not receive the failure notification, it will still be able to select the new last AP after some time through the “procedure for last AP health check and reassignment.”

Based on the type of failure as illustrated by block 327, the CPUs of the fronthaul links involved in the interconnection procedure negotiate what fronthaul links will maintain the interconnections and the CPUs that will provide scheduling.

If an AP serial chain failure has occurred, in block 329, the negotiations include the CPU with the compromised fronthaul segment, since it still can provide DL fronthaul communication thanks to the broadcast structure of the bus for DL. In this block, the CPU of the compromised fronthaul segment and the CPUs of the fronthaul links involved in the interconnection procedure negotiate which fronthaul link will provide the interconnect and the CPU(s) that will provide scheduling.

If a fronthaul bus failure has occurred the negotiations in block 331 do not include the CPU with the compromised (failed) fronthaul segment, since this CPU can provide neither DL nor UL fronthaul communication. In this block, the CPUs of the fronthaul links involved in the interconnection procedure negotiate which fronthaul link will provide the interconnect and the CPU(s) that will provide scheduling.

In both of blocks 329 and 331, the negotiations will be based on the load and quality of the interconnected fronthaul links, and type of failure.

As a result of the negotiations by the CPUs, the interconnection links are established in block 333 according to the negotiation results.

Note that the procedures described above with respect to FIGS. 3A and 3B obey and take advantage of the fronthaul communication structure for cell-free massive MIMO networks based on the RSS, which assumes a broadcast structure for DL and compute-and-forward (pipe-line) on UL. Besides that, the process of failure compensation is started in a distributed way (e.g., by the APs) and is almost seamless from the user perspective.

### Fronthaul Interconnection Approaches

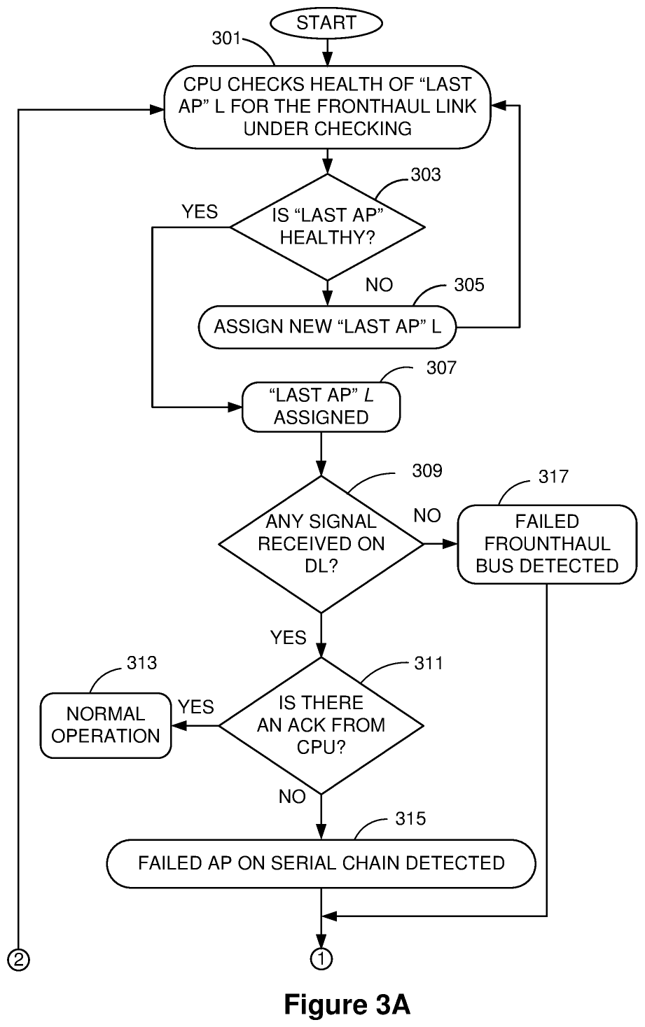

The fronthaul interconnection can be established using different technologies, FIGS. 4A and 4B provides a simplified overview of two alternatives: In FIG. 4A, interconnections are via redundancy fronthaul links and in FIG. 4B, interconnections are via APs. To provide an interconnection, the first approach illustrated in FIG. 4A attaches the redundancy fronthaul links through non-AP circuit-mounted chips (called here as switching units) in the regular fronthaul links whereas the second one makes use of wireless connections from unused or low-loaded APs. In both cases, the fronthaul interconnection procedure can be initiated by APs (e.g., in a distributed way), without CPU dependence. Besides that, multiple fronthaul interconnections technologies can be used simultaneously, e.g., interconnections via redundancy fronthaul links and APs to be used concomitantly, which could be useful, since it would provide a higher degree of failure recuperation with fewer redundancy fronthaul links.

Simulations are performed in a reference scenario to evaluate the performance of the procedures illustrated in FIGS. 3A and 3B.

### Scenario

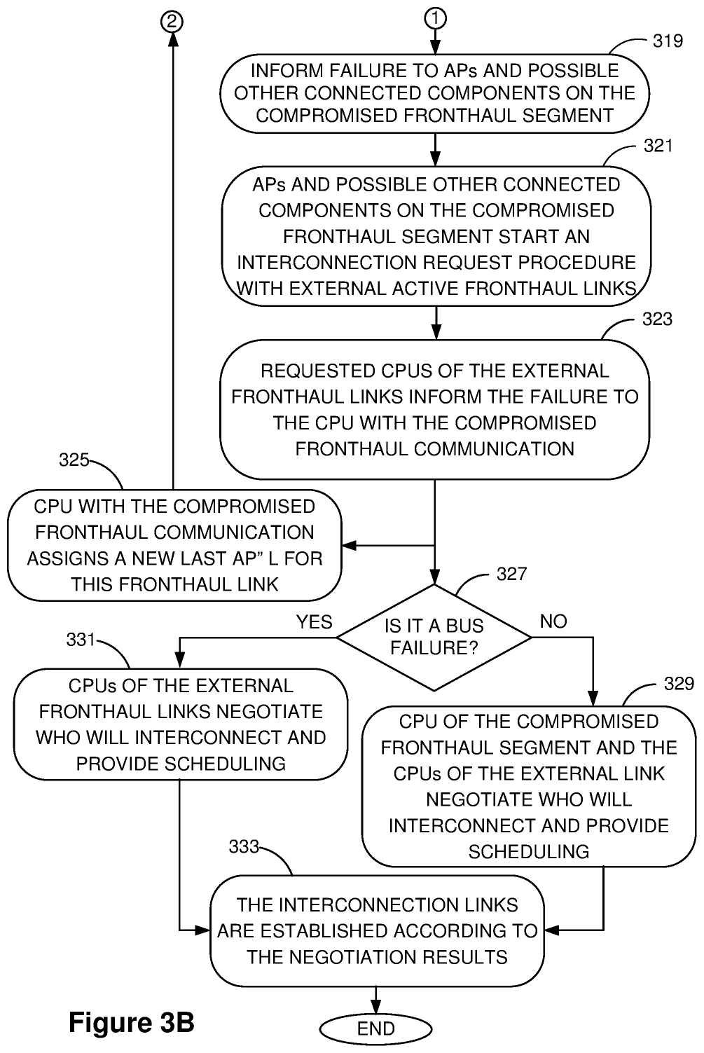

The considered scenario consists of an indoor area of 100×100 m². A cascaded cell-free massive MIMO network, composed of a CPU and two fronthaul links of 10 APs each, covers the perimeter of the area. Each AP has 4 antennas and is installed on the walls at a height of 5 m. Two load cases are considered (i.e., 8 and 16 users), that are uniformly and independently distributed in the scenario. The assumed UE height is of 1.65 m. As failure compensation technology, wireless interconnection with unused or low-loaded APs was employed. FIG. 5 shows the considered scenario for simulations.

### Propagation Model and SE (Spectral Efficiency) Parameters

The propagation model adopted in simulations is the Indoor-Open Office (InH-open) with the LOS probability defined in TR 38.901. The considered signal model considers maximum ratio (MR) precoding. Besides that, each APU aims to serve the 4 strongest UEs in relation to itself. Finally, to generate reliable results, Monte Carlo simulations are carried out. Table 1 shows the main physical layer (PHY) parameters used in simulations.

TABLE 1
PHY parameters used in simulations

| Parameter | Value | |
|---|---|---|
| Duplexing mode | TDD | |
| Coherence interval | 3857 samples | |
| User mobility | 3 | km/h |
| Coherence bandwidth | 150 | kHz |
| Carrier Frequency | 3.5 | GHZ |
| Bandwidth | 100 | MHz |
| Subcarrier spacing | 30 | kHz |
| Number of Physical Resource Blocks | 273 | |
| (PRBs) | | |
| Frame size | 10 | ms |
| Subframe size | 1 | ms |
| Number of slots per subframe | 2 | |
| Number of OFDM symbols per slot | 14 | |
| AP total Tx power | 12 | dBm |
| UE total Tx power | 22 | dBm |

### Performance Evaluation

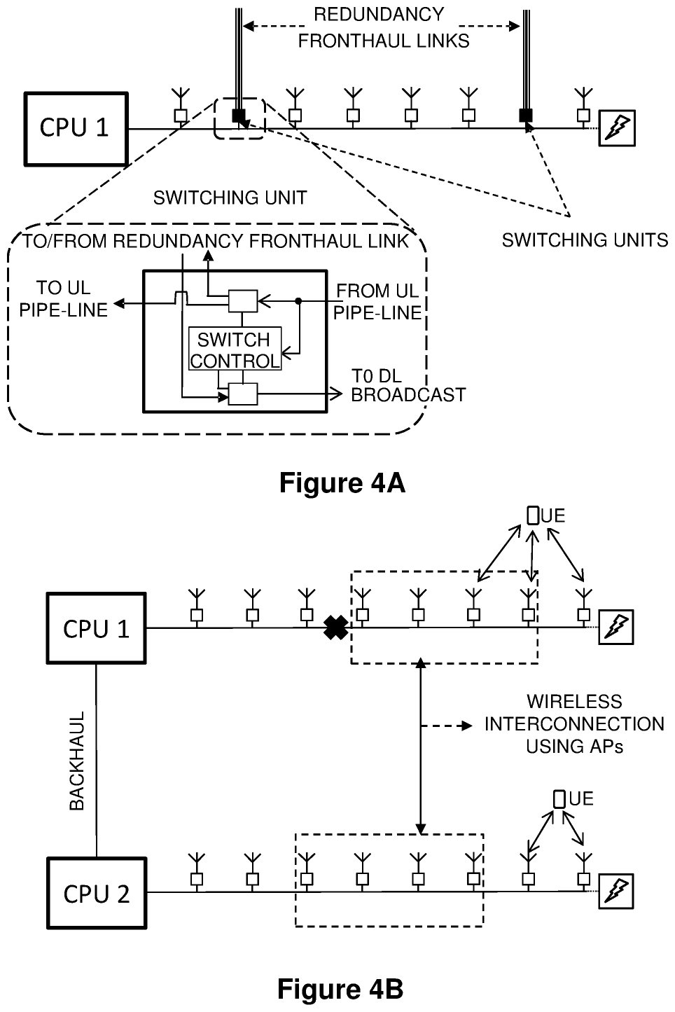

In order to evaluate the performance of the proposed method, FIGS. 6A and 6B show the Cumulative Distribution Function (CDF) versus SE. Five fronthaul communication failure configurations are assumed, as follows where the configurations are compared to fully functional fronthaul links:
a) No failure: a configuration without fronthaul communication failures.
b) Average failure case with no compensation: a configuration without failure compensation and with a fronthaul communication failure (due to an AP or fronthaul bus) impacting the average number of AP affected by all possible failures on the chain of connections.
c) Worst failure case with no compensation: a configuration without failure compensation and with the fronthaul communication failure (due to an AP or fronthaul bus) affecting the largest possible number of APs on the chain of connections.
d) Fronthaul bus failure compensated: a configuration with failure compensation and with one fronthaul communication due to an unhealthy fronthaul bus, and
e) AP failure compensated: a configuration with failure compensation and with one fronthaul communication due to an unhealthy AP on the chain of connections.

FIG. 6 illustrates the five fronthaul communication failure configurations under the considered scenario: (a) no failure, (b) average failure case with no compensation, (c) worst failure case with no compensation, (d) fronthaul bus failure compensated and (e) AP failure compensated.

From FIG. 6, it is possible to note that a fault on fronthaul without failure compensation has higher impacts on the SE for the 50% and 10% worst likely users, with minimum SE reductions up to 84% on the former and up to 100% on the latter. Besides that, it is also noticed an increased failures impact on more crowded scenarios, since increasing the number of users from 8 to 16 led to a SE degradation of more than double. Lastly, the configurations with failure compensation were capable of almost completely mitigate the effects of the failures.

In Table 2, we summarize an analysis of average time until a 20% SE degradation due to cumulative failures (h), with and without the compensation method. The analysis was carried out modeling the possible failures as a continuous-time Markov chain with state definition given by the number, type, and location of failed components. From there, states that caused more than 20% SE degradation were considered absorptive, and the average time to absorption was calculated through Monte Carlo simulations. The obtained results indicate that the protection method has the capacity to increase the service life of unsupervised cascaded cell-free massive MIMO networks based on RSS, since the time to achieve 20% degradation was more than quadrupled for 8 users and tripled for 16 users.

TABLE 2
Cumulative Failures SE Degradation Analysis

| | | Average time until | |
|---|---|---|---|
| Failure | | a 20% SE degradation | Standard |
| compensation | Number of | due to cumulative | Deviation |
| method employed? | Users | failures (h) | (h) |
| No | 8 | 4990 | 110 |
| | 16 | 3440 | 65 |
| Yes | 8 | 21535 | 270 |
| | 16 | 11000 | 218 |

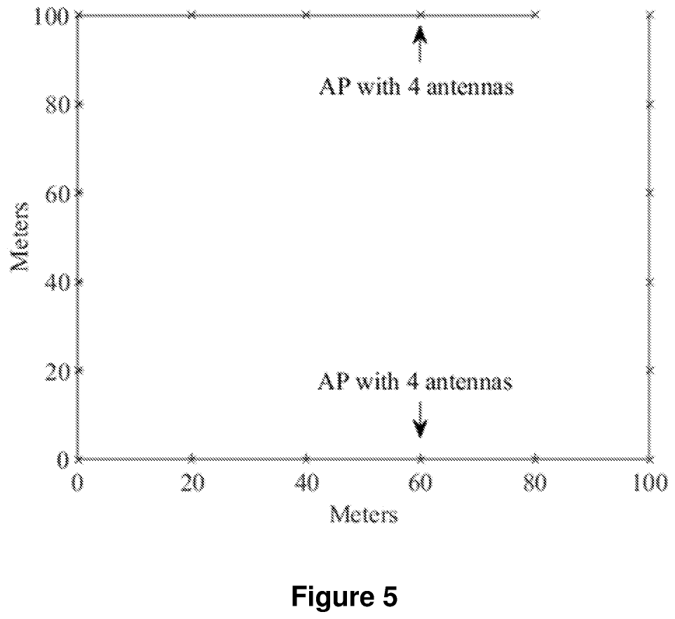

FIG. 7 is a block diagram illustrating elements of a Central Processing Unit (CPU) 100 of a Radio Strip System configured to provide cellular communication according to embodiments of inventive concepts. As shown, the CPU 100 may use transceiver circuitry 701 including a transmitter and a receiver configured to provide uplink and downlink radio communications. The CPU 100 may use network interface circuitry 707 (also referred to as a network interface) configured to provide communications with other CPUs and other Access Points). The CPU 100 may also use processing circuitry 703 (also referred to as a processor) coupled to the transceiver circuitry, and memory circuitry 705 (also referred to as memory) coupled to the processing circuitry. The memory circuitry 705 may include computer readable program code that when executed by the processing circuitry 703 causes the processing circuitry to perform operations according to embodiments disclosed herein. According to other embodiments, processing circuitry 703 may be defined to include memory so that a separate memory circuitry is not required.

As discussed herein, operations by the CPU 100 may use processing circuitry 703, network interface 707, and/or transceiver 701. For example, the CPU 100 may use processing circuitry 703 to control transceiver 701 to transmit downlink communications through transceiver 701 over a radio interface to one or more CPUs and APs and/or to receive uplink communications through transceiver 701 from one or more CPUs and APs over a radio interface. Similarly, the CPU 100 may use processing circuitry 703 to control network interface 707 to transmit communications through network interface 707 to one or more other CPUs and the CPU and/or to receive communications through network interface from one or more other CPUs. Moreover, modules may be stored in memory 705, and these modules may provide instructions so that when instructions of a module are executed by the CPU 100 using processing circuitry 703, processing circuitry 703 performs respective operations discussed above with respect to blocks relating to the CPUs.

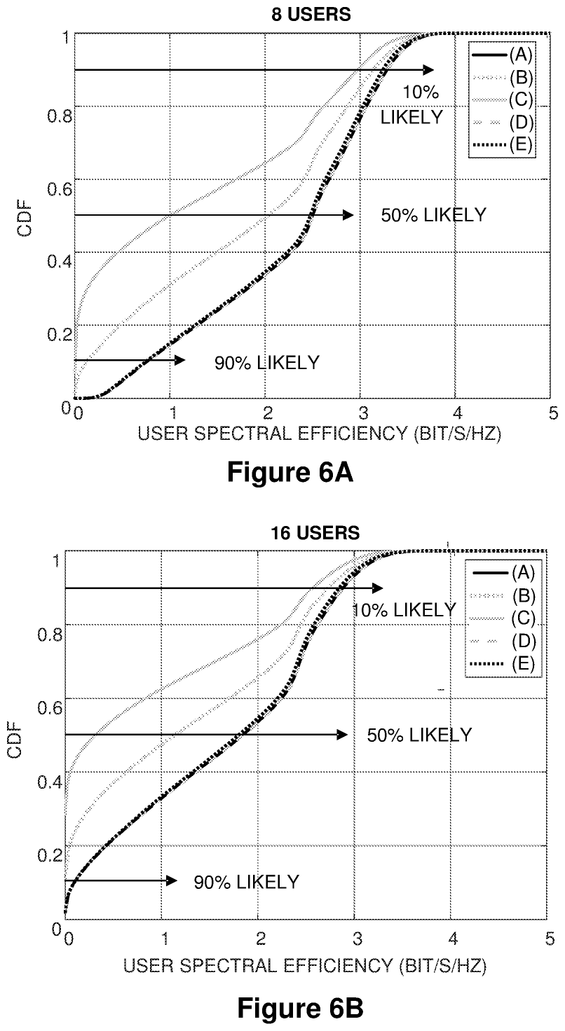

FIG. 8 is a block diagram illustrating elements of an Access Point (AP) 102 of a Radio Strip System configured to provide cellular communication according to embodiments of inventive concepts. As shown, the AP may include transceiver circuitry 801 including a transmitter and a receiver configured to provide uplink and downlink radio communications. The AP 102 may include network interface circuitry 807 (also referred to as a network interface) configured to provide communications with other nodes (e.g., with other Access Points). The AP 102 may also include processing circuitry 803 (also referred to as a processor) coupled to the transceiver circuitry, and memory circuitry 805 (also referred to as memory) coupled to the processing circuitry. The memory circuitry 805 may include computer readable program code that when executed by the processing circuitry 803 causes the processing circuitry to perform operations according to embodiments disclosed herein. According to other embodiments, processing circuitry 803 may be defined to include memory so that a separate memory circuitry is not required.

As discussed herein, operations of the AP 102 may be performed by processing circuitry 803, network interface 807, and/or transceiver 801. For example, processing circuitry 803 may control transceiver 801 to transmit downlink communications through transceiver 801 over a radio interface to one or more mobile terminals UEs and/or to receive uplink communications through transceiver 801 from one or more mobile terminals UEs over a radio interface. Similarly, processing circuitry 803 may control network interface 807 to transmit communications through network interface 807 to one or more other Access Points and the CPU and/or to receive communications through network interface from one or more other Access Points. Moreover, modules may be stored in memory 805, and these modules may provide instructions so that when instructions of a module are executed by processing circuitry 803, processing circuitry 803 performs respective operations discussed above with respect to blocks relating to the Last APs. According to some embodiments, AP 102 and/or an element(s)/function(s) thereof may be embodied as a virtual node/nodes and/or a virtual machine/machines.

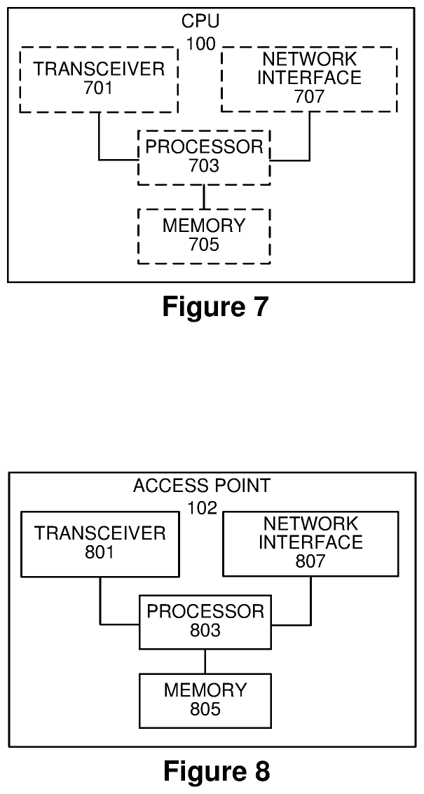

Operations of the CPU (implemented using the structure of the block diagram of FIG. 7) will now be discussed with reference to the flow charts of FIGS. 9-12 according to some embodiments of inventive concepts. For example, modules may be stored in memory 705 of FIG. 7, and these modules may provide instructions so that when the instructions of a module are executed by the CPU 100 using processing circuitry 703, processing circuitry 703 performs respective operations of the flow chart. In the description below, while the CPU 100 may perform the operations in the flow chart, the processing circuitry 703 that the CPU 100 may use shall be used to describe the operations illustrated in the flowcharts.

FIG. 9 illustrates operations the CPU 100 performs for each active shared fronthaul bus of the CPU in various embodiments of a cascade cell-free massive multiple-input and multiple-output, MIMO, network where APs 102 are connected in a cascaded fronthaul chain to the CPU using a shared fronthaul bus. Turning to FIG. 9, in block 901, the processing circuitry 703 assigns an AP at the end of the cascaded fronthaul chain as a last AP. In block 903, the processing circuitry 703, responsive to determining that fronthaul uplink, UL, data is received by the CPU from the last AP, determines that the last AP is healthy.

In block 905, the processing circuitry 703 determines if fronthaul UL data has not been received for a period of time. If fronthaul data has been received, then the CPU 100 periodically checks the health of the last AP and the shared fronthaul bus.

Responsive to fronthaul data not being received for a period of time, blocks 907 to 913 are performed. In block 907, the processing circuitry 703 transmits data addressed to the last AP through the downlink (DL) broadcast structure of the shared fronthaul bus. This is done to determine if the last AP receives it and responds or does not receive it.

In block 909, the processing circuitry 703 determines if an acknowledgement, ACK, signal of the data is received by the CPU in a UL pipeline communication structure. In block 911, the processing circuitry 703, responsive to the ACK signal being received, determines that the last AP is healthy. In block 913, the processing circuitry 703, responsive to the ACK signal not being received, determines that a fronthaul segment until the last AP is not healthy.

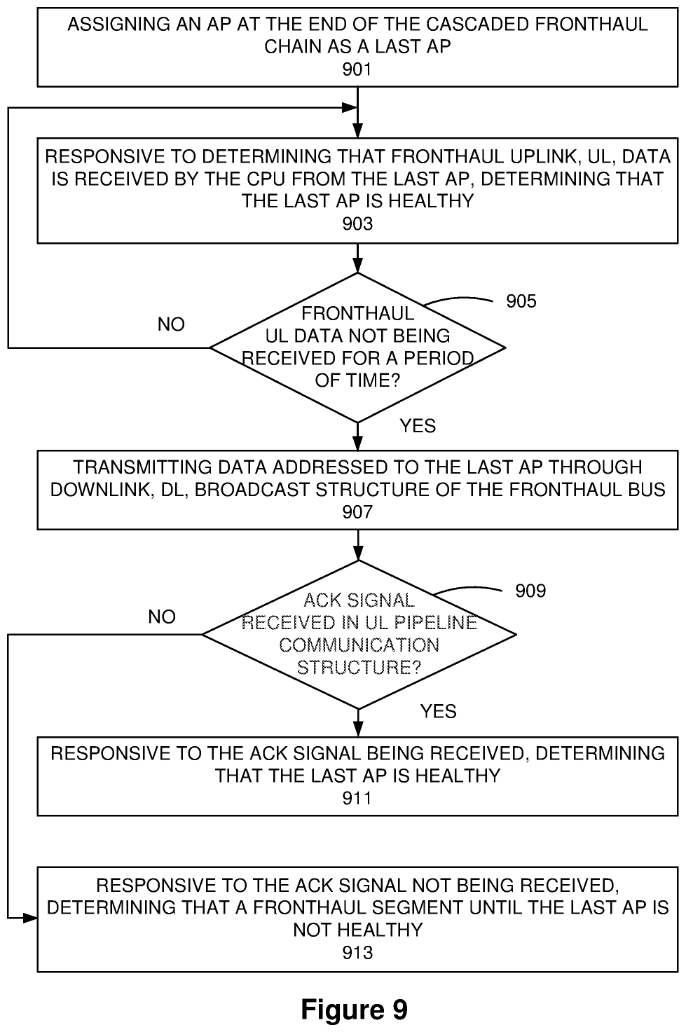

FIG. 10 illustrates an embodiment of assigning another AP in an active fronthaul bus as the last AP where the active fronthaul bus has a number L of APs. As described above, this can happen when the current last AP is not healthy. Turning to FIG. 10, in block 1001, the processing circuitry 703, responsive to determining that the fronthaul segment until the last AP is not healthy, reassigns the last AP as L=L−1 such that the next AP to the last AP is assigned to be the last AP.

In various embodiments, when the next AP is assigned as the last AP, the CPU 100 checks to make sure the next AP assigned as the last AP is healthy and that the fronthaul segment to the next AP assigned as the last AP is healthy. This is illustrated in blocks 1003 to 1013 of FIG. 10.

In block 1003, the processing circuitry 703, responsive to determining that fronthaul uplink, UL, data is received by the CPU from the last AP, determines that the last AP is healthy.

In block 1005, the processing circuitry 703 determines if fronthaul UL data has not been received for a period of time. If fronthaul data has been received, then the CPU 100 determines that the last AP is healthy and the fronthaul segment periodically checks the health of the last AP and the shared fronthaul bus This is similar to block 905.

If fronthaul UL data has not been received for a period of time, the CPU 100 performs blocks 1007-1013, which are the same operations as blocks 907-913 but with the next APS assigned as the last AP. In block 1007, the processing circuitry 703 transmits data addressed to the last AP through the downlink (DL) broadcast structure of the shared fronthaul bus. This is done to determine if the last AP receives it and responds or does not receive it.

In block 1009, the processing circuitry 703 determines if an acknowledgement, ACK, signal of the data is received by the CPU in a UL pipeline communication structure. In block 1011, the processing circuitry 703, responsive to the ACK signal being received, determines that the last AP is healthy. In block 1013, the processing circuitry 703, responsive to the ACK signal not being received, determines that a fronthaul segment until the last AP is not healthy.

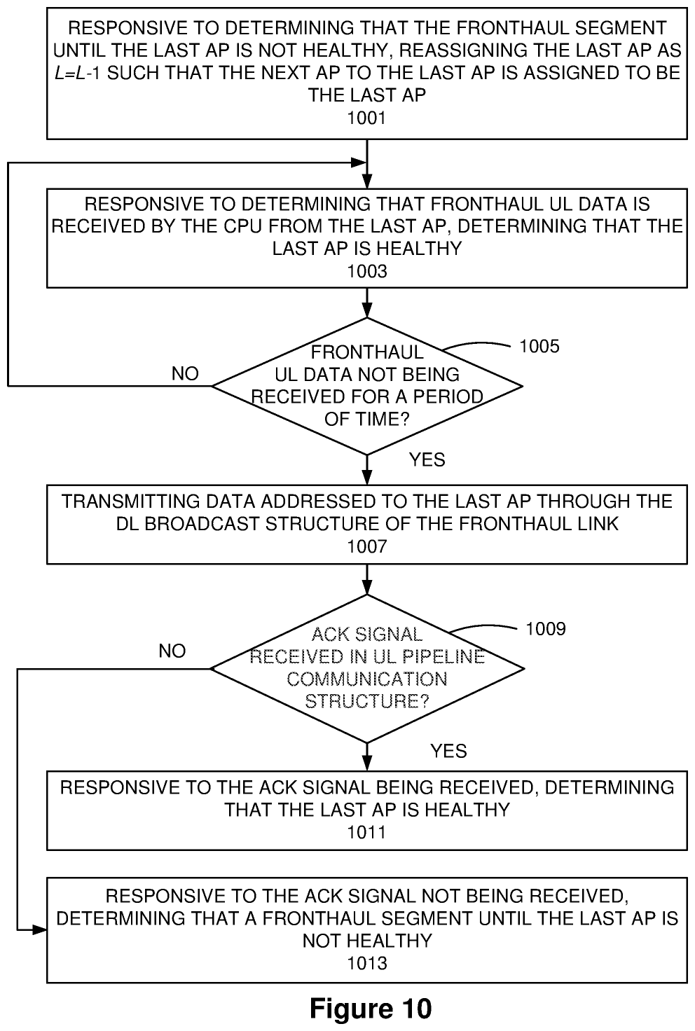

The CPU 100 may receive an indication from another CPU about a failure. An embodiment of this is illustrated in FIG. 11. Turning to FIG. 11, in block 1101, the processing circuitry 703 receives an indication from another CPU of another cascaded cell-free massive MIMO network of a failure in a fronthaul link of the CPU 100.

In block 1103, the processing circuitry 703, responsive to receiving the indication, reassigns the last AP be assigning the next AP as the last AP and perform operations until the last AP is determined to be healthy. In other words, the processing circuitry 703 performs blocks 301-305 (and blocks 1001 to 1013) until the processing circuitry 703 determines that the last AP is a healthy last AP.

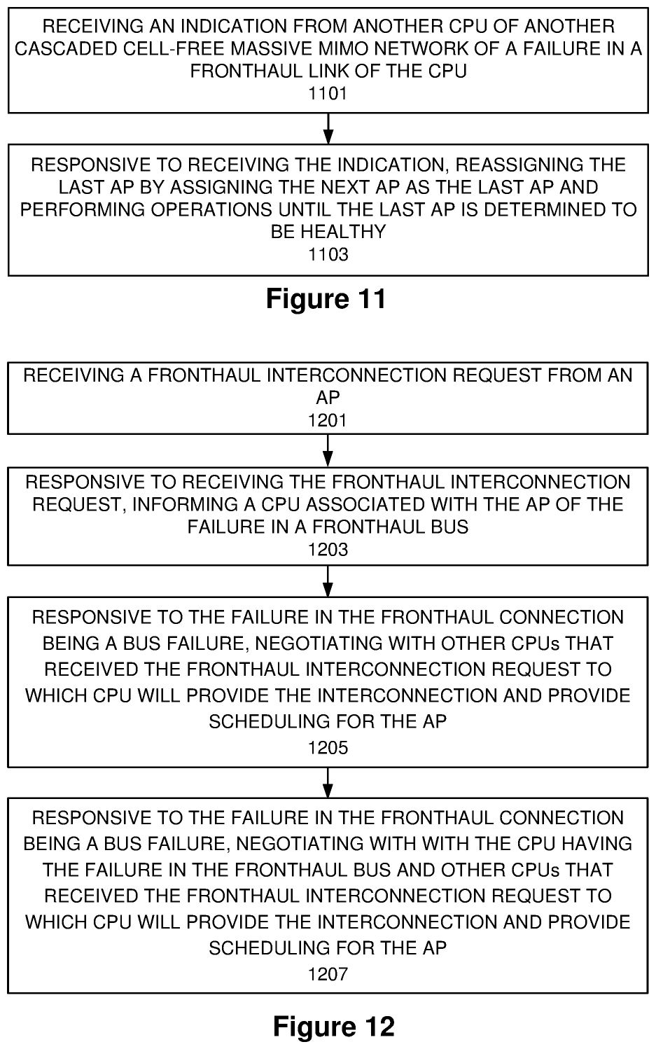

In some embodiments, the CPU 100 may receive an interconnection request from an AP of a fronthaul link of another CPU. This is illustrated in FIG. 12.

Turning to FIG. 12, in block 1201, the processing circuitry 703 receives a fronthaul interconnection request from an AP. In block 1203, the processing circuitry 703, responsive to receiving the fronthaul interconnection request, informs a CPU associated with the AP of the failure in a fronthaul bus.

In block 1205, the processing circuitry 703, responsive to the failure in the fronthaul connection being a bus failure, negotiates with other CPUs that received the fronthaul interconnection request to which CPU will provide the interconnection and provide scheduling for the AP. As described above, the negotiation may take into account loading of CPUs, latency requirements, etc.

In block 1207, the processing circuitry 703, responsive to the failure in the fronthaul connection being a bus failure, negotiates with the CPU having the failother CPUs that received the fronthaul interconnection request to which CPU will provide the interconnection and provide scheduling for the AP. As described above, the negotiation may take into account loading of CPUs, latency requirements, etc.

Responsive to being responsible for the AP (e.g., as a result of the negotiations), the processing circuitry 703 establishes an interconnection link with the AP. In some embodiments, the processing circuitry 703 establishes the interconnection link by establishing the interconnection link via a wireless interconnection with unused or low-loaded APs in a failed section of the fronthaul bus having the failure. In other embodiments, the processing circuitry 703 establishes the interconnection link by establishing the interconnection link via redundancy fronthaul connections and switching units.

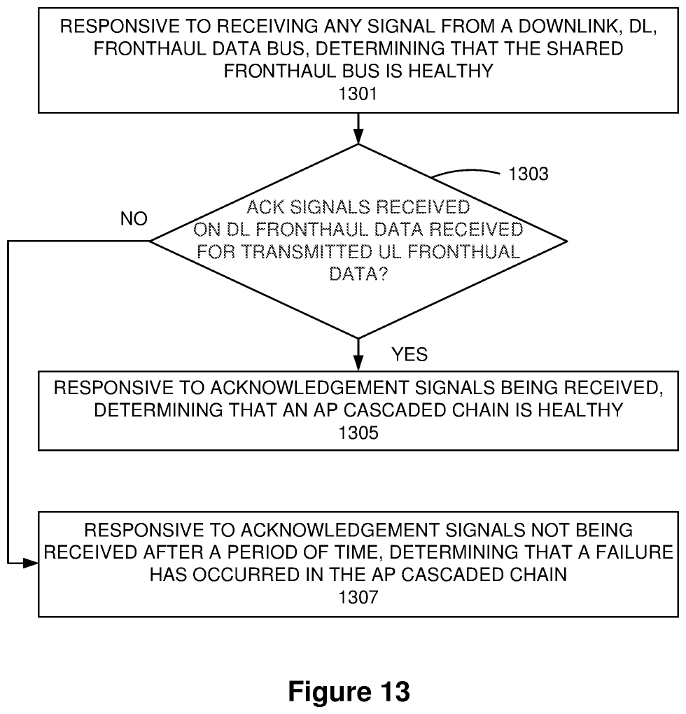

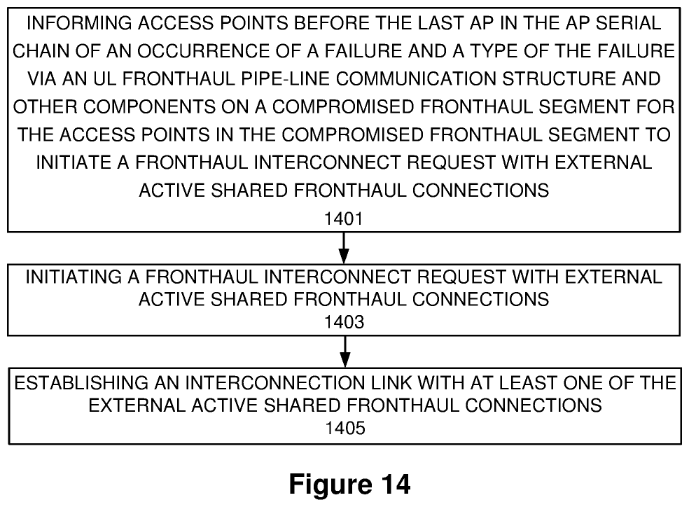

Operations of the last AP (implemented using the structure of the block diagram of FIG. 8) of a cascaded cell-free massive multiple-input and multiple-output, MIMO, network where APs are connected in a cascaded chain to a central processing unit, CPU, using a shared fronthaul bus will now be discussed with reference to the flow charts of FIGS. 13-14 according to some embodiments of inventive concepts. For example, modules may be stored in memory 805 of FIG. 8, and these modules may provide instructions so that when the instructions of a module are executed by processing circuitry 803, processing circuitry 803 performs respective operations of the flow charts.

FIG. 13 illustrates an embodiment where the last AP checks health of the fronthaul bus Turning to FIG. 13, in block 1301, the processing circuitry 803, responsive to receiving any signal from a downlink, DL, fronthaul bus, determines that the shared fronthaul bus is healthy. In block 1303, the processing circuitry 803 verifies whether acknowledgement signals are received on DL fronthaul data received for transmitted uplink, UL, fronthaul data.

In block 1305, the processing circuitry 803, responsive to acknowledgement signals being received, determines that an AP cascaded chain is healthy. In block 1307, the processing circuitry 803, responsive to acknowledgement signals not being received after a period of time, determines that a failure has occurred in the AP cascaded chain. Typically, the processing circuitry 803 determines that the failure that has occurred in the AP cascaded chain is a shared bus failure.

FIG. 14 illustrates an embodiment of how the last AP communicates with other APs in the failed AP cascaded chain (e.g., the shared bus failure). Turning to FIG. 14, in block 1401, the processing circuitry 803 informs access points before the last AP in the AP serial chain of an occurrence of a failure and a type of the failure via a UL fronthaul pipe-line communication structure and other components on a compromised fronthaul segment for the access points in the compromised fronthaul segment to initiate a fronthaul interconnect request with external active shared fronthaul buses.

In block 1403, the processing circuitry 803 initiates a fronthaul interconnection request with external active shared fronthaul connections. In block 1405, the processing circuitry 803 establishes an interconnection link with at least one of the external active fronthaul connections.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

### EMBODIMENTS

Embodiment 1. A method performed by a central processing unit, CPU, (100) of a cascade cell-free massive multiple-input and multiple-output, MIMO, network where access points, APs, (102) are connected in a cascaded fronthaul chain to the CPU using a shared fronthaul bus, the method comprising:
for each shared fronthaul bus of the CPU that is active:
   assigning (901) an AP at the end of the cascaded fronthaul chain as a last AP;
   responsive to determining that fronthaul uplink, UL, data is received by the CPU from the last AP, determining (903) that the last AP is healthy; and
   responsive to fronthaul UL data not being received (905) for a period of time:
      transmitting (907) data addressed to the last AP through downlink, DL, broadcast structure of the shared fronthaul bus;
      determining (909) if an acknowledgement, ACK, signal of the data is received by the CPU in a UL pipeline communication structure;
      responsive to the ACK signal being received, determining (911) that the last AP is healthy; and
      responsive to the ACK signal not being received, determining (913) that a fronthaul segment until the last AP is not healthy.
         Embodiment 2. The method of Embodiment 1, wherein a number of APs in an active fronthaul bus is a number L, the method further comprising:
responsive to determining that the fronthaul segment until the last AP is not healthy, reassigning (1001) the last AP as L=L−1 such that the next AP to the last AP is assigned to be the last AP;
subsequent to reassigning the last AP, responsive to determining that fronthaul uplink, UL, data is received by the CPU from the last AP, determining (1003) that the last AP is healthy; and
subsequent to reassigning the last AP, responsive to fronthaul UL data not being received (1005) for a period of time:
   transmitting (1007) data addressed to the last AP through downlink, DL, broadcast structure of the fronthaul link;
   determining (1009) if an acknowledgement signal of the data is received by the CPU in the UL pipeline communication structure;
   responsive to the acknowledgement signal being received, determining (1011) that the last AP is healthy; and
   responsive to the acknowledgement signal not being received, determining (1013) that a fronthaul segment until the last AP is not healthy
      Embodiment 3. The method of any of Embodiments 1-2, further comprising:
receiving (1101) an indication from another CPU of another cascaded cell-free massive MIMO network of a failure in a fronthaul bus of the CPU;
responsive to receiving the indication, reassigning (1103) the last AP by assigning the next AP as the last AP and performing operations until the last AP is determined to be healthy.
   Embodiment 4. The method of any of Embodiments 1-3, further comprising:
receiving (1201) a fronthaul interconnection request from an AP; and
responsive to receiving the fronthaul interconnection request, informing (1203) a CPU associated with the AP of the failure in a fronthaul bus.
   Embodiment 5. The method of Embodiment 4, further comprising:
responsive to the failure in the fronthaul connection being a bus failure, negotiating (1205) with other CPUs that received the fronthaul interconnection request to which CPU will provide the interconnection and provide scheduling for the AP.
   Embodiment 6. The method of Embodiment 4, further comprising:
responsive to the failure in the fronthaul bus connection being an AP failure on the cascaded chain, negotiating (1207) with the CPU having the failure in the fronthaul bus and other CPUs that received the fronthaul interconnection request to which CPU will provide the interconnection and provide scheduling for the AP.
   Embodiment 7. The method of any of Embodiments 5-6, further comprising:
responsive to being responsible for the AP, establishing an interconnection link with the AP.
   Embodiment 8. The method of Embodiment 7, wherein establishing the interconnection link comprises establishing the interconnection link via a wireless interconnection with unused or low-loaded APs in a failed section of the fronthaul bus having the failure.
   Embodiment 9. The method of Embodiment 7, wherein establishing the interconnection link comprises establishing the interconnection link via redundancy fronthaul connections and switching units.
   Embodiment 10. A method performed by a last access point, AP, (102) of a cascaded cell-free massive multiple-input and multiple-output, MIMO, network where access points, APs, (102) are connected in a cascaded chain to a central processing unit, CPU, (100) using a shared fronthaul bus, the method comprising:
responsive to receiving any signal from a downlink, DL, fronthaul data, determining (1301) that the shared fronthaul bus is healthy;
verifying (1303) whether acknowledgement signals are received on DL fronthaul data received for transmitted uplink, UL, fronthaul data;
responsive to acknowledgement signals being received, determining (1305) that an AP cascaded chain is healthy; and
responsive to acknowledgement signals not being received after a period of time, determining (1307) that a failure has occurred in the AP cascaded chain.
   Embodiment 11. The method of Embodiment 10, wherein determining that the failure has occurred in the AP cascaded chain comprises determining that a shared fronthaul bus failure has occurred.
   Embodiment 12. The method of any of Embodiments 10-11, further comprising:
informing (1401) access points before the last AP in the AP serial chain of an occurrence of a failure and a type of the failure via a UL fronthaul pipe-line communication structure and other components on a compromised fronthaul segment for the access points in the compromised fronthaul segment to initiate a fronthaul interconnect request with external active shared fronthaul connections.
   Embodiment 13. The method of any of Embodiments 10-12, further comprising:
initiating (1403) a fronthaul interconnect request with external active fronthaul connections.
   Embodiment 14. The method of Embodiments 13, further comprising:
establishing (1405) an interconnection link with at least one of the external active fronthaul connections.
   Embodiment 15. A central processing unit, CPU, (100) of a cascade cell-free massive multiple-input and multiple-output, MIMO, network where access points, APs, (102) are connected in a cascaded fronthaul chain to the CPU using a shared fronthaul bus, the CPU adapted to:
for each shared fronthaul bus of the CPU that is active:
   assign (901) an AP at the end of the cascaded fronthaul chain as a last AP;
   responsive to determining that fronthaul uplink, UL, data is received by the CPU from the last AP, determine (903) that the last AP is healthy; and
   responsive to fronthaul UL data not being received (905) for a period of time:
      transmit (907) data addressed to the last AP through downlink, DL, broadcast structure of the shared fronthaul bus;
      determine (909) if an acknowledgement, ACK, signal of the data is received by the CPU in a UL pipeline communication structure;
      responsive to the ACK signal being received, determine (911) that the last AP is healthy; and
      responsive to the ACK signal not being received, determine (913) that a fronthaul segment until the last AP is not healthy.
         Embodiment 16. The CPU (100) of Embodiment 15, wherein the CPU (100) is further adapted to perform in accordance with Embodiments 2-9.
         Embodiment 17. A central processing unit, CPU, (100) of a cascade cell-free massive multiple-input and multiple-output, MIMO, network where access points, APs, (102) are connected in a cascaded fronthaul chain to the CPU using a shared fronthaul bus, the CPU comprising:
processing circuitry (703); and
memory (705) coupled with the processing circuitry, wherein the memory includes instructions that when executed by the processing circuitry causes the CPU to perform operations comprising:
for each shared fronthaul bus of the CPU that is active:
   assigning (901) an AP at the end of the cascaded fronthaul chain as a last AP;
   responsive to determining that fronthaul uplink, UL, data is received by the CPU from the last AP, determining (903) that the last AP is healthy; and
   responsive to fronthaul UL data not being received (905) for a period of time:
      transmitting (907) data addressed to the last AP through downlink, DL, broadcast structure of the shared fronthaul bus;
      determining (909) if an acknowledgement, ACK, signal of the data is received by the CPU in a UL pipeline communication structure;
      responsive to the ACK signal being received, determining (911) that the last AP is healthy; and
      responsive to the ACK signal not being received, determining (913) that a fronthaul segment until the last AP is not healthy.
         Embodiment 18. The CPU (100) of Embodiment 17, wherein the memory includes further instructions that when executed by the processing circuitry causes the CPU to perform operations in accordance with Embodiments 2-9.
         Embodiment 19. A last access point, AP, (102) of a cascaded cell-free massive multiple-input and multiple-output, MIMO, network where access points, APs, (102) are connected in a cascaded chain to a central processing unit, CPU, (100) using a shared fronthaul bus, the last AP adapted to:
responsive to receiving any signal from a downlink, DL, fronthaul data, determine (1301) that the shared fronthaul bus is healthy;
verify (1303) whether acknowledgement signals are received on DL fronthaul data received for transmitted uplink, UL, fronthaul data;
responsive to acknowledgement signals being received, determine (1305) that an AP cascaded chain is healthy; and
responsive to acknowledgement signals not being received after a period of time, determine (1307) that a failure has occurred in the AP cascaded chain.
   Embodiment 20. The last AP of Embodiment 19, wherein the last AP is further adapted to perform in accordance with Embodiments 11-14.
   Embodiment 21. A last access point, AP, (102) of a cascaded cell-free massive multiple-input and multiple-output, MIMO, network where access points, APs, (102) are connected in a cascaded chain to a central processing unit, CPU, (100) using a shared fronthaul bus, the last AP comprising:
processing circuitry (803); and
memory (805) coupled with the processing circuitry, wherein the memory includes instructions that when executed by the processing circuitry causes the CPU to perform operations comprising:
   responsive to receiving any signal from a downlink, DL, fronthaul data, determining (1301) that the shared fronthaul bus is healthy;
   verifying (1303) whether acknowledgement signals are received on DL fronthaul data received for transmitted uplink, UL, fronthaul data;
   responsive to acknowledgement signals being received, determining (1305) that an AP cascaded chain is healthy; and
   responsive to acknowledgement signals not being received after a period of time, determining (1307) that a failure has occurred in the AP cascaded chain.
      Embodiment 22. The last AP of Embodiment 19, wherein the memory comprises includes further instructions that when executed by the processing circuitry causes the last AP to perform in accordance with Embodiments 11-14.
      Embodiment 23. A computer program comprising program code to be executed by processing circuitry (703) of a central processing unit, CPU, (100), whereby execution of the program code causes the CPU (100) to perform operations comprising:
for each shared fronthaul bus of the CPU that is active:
   assigning (901) an AP at the end of the cascaded fronthaul chain as a last AP;
   responsive to determining that fronthaul uplink, UL, data is received by the CPU from the last AP, determining (903) that the last AP is healthy; and
   responsive to fronthaul UL data not being received (905) for a period of time:
      transmitting (907) data addressed to the last AP through downlink, DL, broadcast structure of the shared fronthaul bus;
      determining (909) if an acknowledgement, ACK, signal of the data is received by the CPU in a UL pipeline communication structure;
      responsive to the ACK signal being received, determining (911) that the last AP is healthy; and responsive to the ACK signal not being received, determining (913) that a fronthaul segment until the last AP is not healthy.
         Embodiment 24. The computer program of Embodiment 23 comprising further program code to be executed by the processing circuitry (703) of the CPU (100), whereby execution of the further program code causes the CPU (100) to perform according to any of Embodiments 2-9.
         Embodiment 25. A computer program product comprising a non-transitory storage medium including program code to be executed by processing circuitry (703) of a Central Processing Unit, CPU, (100), whereby execution of the program code causes the CPU (100) to perform operations comprising:
for each shared fronthaul bus of the CPU that is active:
   assigning (901) an AP at the end of the cascaded fronthaul chain as a last AP;
   responsive to determining that fronthaul uplink, UL, data is received by the CPU from the last AP, determining (903) that the last AP is healthy; and
   responsive to fronthaul UL data not being received (905) for a period of time:
      transmitting (907) data addressed to the last AP through downlink, DL, broadcast structure of the shared fronthaul bus;
      determining (909) if an acknowledgement, ACK, signal of the data is received by the CPU in a UL pipeline communication structure;
      responsive to the ACK signal being received, determining (911) that the last AP is healthy; and
      responsive to the ACK signal not being received, determining (913) that a fronthaul segment until the last AP is not healthy.
         Embodiment 26. The computer program product of Embodiment 25, wherein the non-transitory storage medium includes further program code to be executed by processing the circuitry (703) of the CPU (100) whereby execution of the program code causes the CPU (100) to perform operations according to any of embodiments 2-9.
         Embodiment 27. A computer program comprising program code to be executed by processing circuitry (803) of a last access point, AP, (102), whereby execution of the program code causes the last APU (102) to perform operations comprising:
responsive to receiving any signal from a downlink, DL, fronthaul data, determining (1301) that the shared fronthaul bus is healthy;
verifying (1303) whether acknowledgement signals are received on DL fronthaul data received for transmitted uplink, UL, fronthaul data;
responsive to acknowledgement signals being received, determining (1305) that an AP cascaded chain is healthy; and
responsive to acknowledgement signals not being received after a period of time, determining (1307) that a failure has occurred in the AP cascaded chain.
   Embodiment 28. The computer program of Embodiment 27 comprising further program code to be executed by the processing circuitry (803) of the last AP (102), whereby execution of the further program code causes the last AP (102) to perform according to any of Embodiments 11-14.
   Embodiment 29. A computer program product comprising a non-transitory storage medium including program code to be executed by processing circuitry (803) of a last access point, AP, (102), whereby execution of the program code causes the last APU (102) to perform operations comprising:
responsive to receiving any signal from a downlink, DL, fronthaul data, determining (1301) that the shared fronthaul bus is healthy;
verifying (1303) whether acknowledgement signals are received on DL fronthaul data received for transmitted uplink, UL, fronthaul data;
responsive to acknowledgement signals being received, determining (1305) that an AP cascaded chain is healthy; and
responsive to acknowledgement signals not being received after a period of time, determining (1307) that a failure has occurred in the AP cascaded chain.
   Embodiment 26. The computer program product of Embodiment 25, wherein the non-transitory storage medium includes further program code to be executed by the processing the circuitry (803) of the last AP (102) whereby execution of the program code causes the last AP (102) to perform operations according to any of embodiments 11-14.

Explanations are provided below for various abbreviations/acronyms used in the present disclosure.

| Abbreviation | Explanation |
|---|---|
| ACK | Acknowledgment signal |
| AP | Access Point |
| 5G | Fifth-Generation Mobile Networks |
| APU | Access Point Unit |
| CDF | Cumulative Distribution Function |
| CF | Cell-Free |
| CPU | Central Processing Unit |
| DL | Downlink |
| RSS | Radio Stripe System |
| LOS | Line-of-Sight |
| MIMO | Multiple-Input-Multiple-Output |
| PHY | Physical Layer |
| QoS | Quality of Service |
| SE | Spectral Efficiency |
| TDD | Time Division Duplexing |
| UE | User Equipment |
| UL | Uplink |

1. A method performed by a central processing unit, CPU, of a cascade cell-free massive multiple-input and multiple-output, MIMO, network where access points, APs, are connected in a cascaded fronthaul chain to the CPU using a shared fronthaul bus, the method comprising:
for each shared fronthaul bus of the CPU that is active:
assigning an AP at the end of the cascaded fronthaul chain as a last AP;
responsive to determining that fronthaul uplink, UL, data is received by the CPU from the last AP, determining that the last AP is healthy; and
responsive to fronthaul UL data not being received for a period of time:
transmitting data addressed to the last AP through downlink, DL, broadcast structure of the shared fronthaul bus;
determining if an acknowledgement, ACK, signal of the data is received by the CPU in a UL pipeline communication structure;
responsive to the ACK signal being received, determining that the last AP is healthy; and
responsive to the ACK signal not being received, determining that a fronthaul segment until the last AP is not healthy.

2. The method of claim 1, wherein a number of APs in an active fronthaul bus is a number L, the method further comprising:
responsive to determining that the fronthaul segment until the last AP is not healthy, reassigning the last AP as L=L−1 such that the next AP to the last AP is assigned to be the last AP;
subsequent to reassigning the last AP, responsive to determining that fronthaul uplink, UL, data is received by the CPU from the last AP, determining that the last AP is healthy; and
subsequent to reassigning the last AP, responsive to fronthaul UL data not being received for a period of time:
transmitting data addressed to the last AP through downlink, DL, broadcast structure of the fronthaul link;
determining if an acknowledgement signal of the data is received by the CPU in the UL pipeline communication structure;
responsive to the acknowledgement signal being received, determining that the last AP is healthy; and
responsive to the acknowledgement signal not being received, determining that a fronthaul segment until the last AP is not healthy.

3. The method of claim 1, further comprising:
receiving an indication from another CPU of another cascaded cell-free massive MIMO network of a failure in a fronthaul bus of the CPU;
responsive to receiving the indication, reassigning the last AP by assigning the next AP as the last AP and performing operations until the last AP is determined to be healthy.

4. The method of claim 1, further comprising:
receiving a fronthaul interconnection request from an AP; and
responsive to receiving the fronthaul interconnection request, informing a CPU associated with the AP of the failure in a fronthaul bus.

5. The method of claim 4, further comprising:
responsive to the failure in the fronthaul connection being a bus failure, negotiating with other CPUs that received the fronthaul interconnection request to which CPU will be responsible for providing the interconnection and providing scheduling for the AP.

6. The method of claim 4, further comprising:
responsive to the failure in the fronthaul bus connection being an AP failure on the cascaded chain, negotiating with the CPU having the failure in the fronthaul bus and other CPUs that received the fronthaul interconnection request to which CPU will be responsible for providing the interconnection and providing scheduling for the AP.

7. The method of claim 5, further comprising:
responsive to being responsible for providing the interconnection and providing scheduling for the AP, establishing an interconnection link with the AP.

8. The method of claim 7, wherein establishing the interconnection link comprises establishing the interconnection link via a wireless interconnection with unused or low-loaded APs in a failed section of the fronthaul bus having the failure.

9. The method of claim 7, wherein establishing the interconnection link comprises establishing the interconnection link via redundancy fronthaul connections and switching units.

10. A method performed by a last access point, AP, of a cascaded cell-free massive multiple-input and multiple-output, MIMO, network where access points, APs, are connected in a cascaded chain to a central processing unit, CPU, using a shared fronthaul bus, the method comprising:
responsive to receiving any signal from a downlink, DL, fronthaul data, determining that the shared fronthaul bus is healthy;
verifying whether acknowledgement signals are received on DL fronthaul data for transmitted uplink, UL, fronthaul data;
responsive to acknowledgement signals being received, determining that an AP cascaded chain is healthy; and
responsive to acknowledgement signals not being received after a period of time, determining that a failure has occurred in the AP cascaded chain.

11. The method of claim 10, wherein determining that the failure has occurred in the AP cascaded chain comprises determining that a shared fronthaul bus failure has occurred.

12. The method of claim 10, further comprising:
informing access points before the last AP in the AP serial chain of an occurrence of a failure and a type of the failure via a UL fronthaul pipe-line communication structure and other components on a compromised fronthaul segment for the access points in the compromised fronthaul segment to initiate a fronthaul interconnect request with external active shared fronthaul connections.

13. The method of claim 10, further comprising:
initiating a fronthaul interconnect request with external active fronthaul connections.

14. The method of claim 13, further comprising:
establishing an interconnection link with at least one of the external active fronthaul connections.

15.-16. (canceled)

17. A central processing unit, CPU, of a cascade cell-free massive multiple-input and multiple-output, MIMO, network where access points, APs, are connected in a cascaded fronthaul chain to the CPU using a shared fronthaul bus, the CPU comprising:
processing circuitry; and
memory coupled with the processing circuitry, wherein the memory includes instructions that when executed by the processing circuitry causes the CPU to perform operations comprising:
for each shared fronthaul bus of the CPU that is active:
assigning an AP at the end of the cascaded fronthaul chain as a last AP;
responsive to determining that fronthaul uplink, UL, data is received by the CPU from the last AP, determining that the last AP is healthy; and
responsive to fronthaul UL data not being received for a period of time:
transmitting data addressed to the last AP through downlink, DL, broadcast structure of the shared fronthaul bus;
determining if an acknowledgement, ACK, signal of the data is received by the CPU in a UL pipeline communication structure;
responsive to the ACK signal being received, determining that the last AP is healthy; and
responsive to the ACK signal not being received, determining that a fronthaul segment until the last AP is not healthy.

18. The CPU of claim 17, wherein a number of APs in an active fronthaul bus is a number L, wherein the memory includes further instructions that when executed by the processing circuitry causes the CPU to
responsive to determining that the fronthaul segment until the last AP is not healthy, reassign the last AP as L=L−1 such that the next AP to the last AP is assigned to be the last AP;
subsequent to reassigning the last AP, responsive to determining that fronthaul uplink, UL, data is received by the CPU from the last AP, determine that the last AP is healthy; and
subsequent to reassigning the last AP, responsive to fronthaul UL data not being received for a period of time:
transmit data addressed to the last AP through downlink, DL, broadcast structure of the fronthaul link;
determine if an acknowledgement signal of the data is received by the CPU in the UL pipeline communication structure;
responsive to the acknowledgement signal being received, determine that the last AP is healthy; and
responsive to the acknowledgement signal not being received, determine that a fronthaul segment until the last AP is not healthy.

19.-20. (canceled)

21. A last access point, AP, of a cascaded cell-free massive multiple-input and multiple-output, MIMO, network where access points, APs, are connected in a cascaded chain to a central processing unit, CPU, using a shared fronthaul bus, the last AP comprising:
processing circuitry; and
memory coupled with the processing circuitry, wherein the memory includes instructions that when executed by the processing circuitry causes the CPU to perform operations comprising:
responsive to receiving any signal from a downlink, DL, fronthaul data, determining that the shared fronthaul bus is healthy;
verifying whether acknowledgement signals are received on DL fronthaul data received for transmitted uplink, UL, fronthaul data;
responsive to acknowledgement signals being received, determining that an AP cascaded chain is healthy; and
responsive to acknowledgement signals not being received after a period of time, determining that a failure has occurred in the AP cascaded chain.

22. The last AP of claim 21, wherein determining that the failure has occurred in the AP cascaded chain comprises determining that a shared fronthaul bus failure has occurred.
